(19) United States
(12) Patent Application Publication
(10) Pub. No.: US 2004/0136267 A1
(43) Pub. Date: Jul. 15, 2004

(54) Dual imaging sonde including a rotationally and vertically offset second imaging tool

(76) Inventors: George R. Kear, Slidell, LA (US); Anish Kumar, River Ridge, LA (US); Brian Briscoe, Marrero, LA (US); Tom Teipner, Mandeville, LA (US)

Correspondence Address: SCHLUMBERGER OILFIELD SERVICES, 200 GILLINGHAM LANE, MD 200-9, SUGAR LAND, TX, 77478, US

(21) Appl. No.: 10/248,338

(22) Filed: Jan. 10, 2003

(51) Int. Cl. G01V 1/00

(52) U.S. Cl. 367/25

(57) ABSTRACT

An Oil Based Mud Imaging (OBMI) sonde adapted to be disposed in a wellbore includes a first imaging tool and at least one additional imaging tool connected to the first imaging tool, the additional imaging tool having a rotational offset and a significant vertical offset with respect to the first imaging tool when the OBMI sonde is disposed in the wellbore. The first imaging tool is connected to the additional imaging tool via a special adapter disposed between the first imaging tool and the additional imaging tool. The bottom of the first imaging tool plugs into one end of the special adapter and the top of the additional imaging tool plugs into the other end of the special adapter. The special adapter is made in a special way such that, when the bottom end of the first imaging tool is plugged into the one end of the special adapter and the top end of the additional imaging tool is plugged into the other end of the special adapter, the additional imaging tool is offset both vertically and rotationally with respect to the first imaging tool. The rotational offset requires that four pads of the additional imaging tool be offset azimuthally by an angle of approximately 45 degrees with respect to four pads of the first imaging tool. As a result, the OBMI sonde generates an output record medium having eight tracks instead of the traditional four tracks thereby giving a user a better view of a formation penetrated by the wellbore.

### BACKGROUND OF INVENTION

The subject matter of the present invention relates to a dual oil based mud imaging (OBMI) sonde adapted to be disposed in a wellbore, and, more particularly, to two oil based mud imaging (OBMI) sondes used in combination and joined together by a special adaptor, the second OBMI sonde having sensors which are offset azimuthally by a predetermined angle relative to the sensors of the first OBMI sonde. As a result, the second OBMI sonde will survey areas of the wellbore which are not being surveyed by the first OBMI sonde.

It has always been a challenge for Petroleum Geologists worldwide to find a means to examine and understand the geological characteristics of subsurface lithologic formations. Technological advances in the petroleum industry have made it possible to acquire measurements of the physical properties of subsurface rocks, including micro-resistivity measurements which can be processed into electrical images. A problem area has been wells drilled using oil-base and synthetics-base mud systems. Wells are drilled using oil-base and synthetics-base mud systems in order to minimize any economic risks and maximize drilling efficiency. These mud systems are extremely resistive. Conventional borehole imaging sensor-arrays cannot acquire images in these non-conductive fluids. To make possible borehole resistivity image acquisition in these non-conductive fluids, specialized sensors have been developed to obtain high-resolution images of the borehole. just as image data from conventional imaging devices can be used in studies for structural and stratigraphic interpretation, including thin-bed detection, compartmentalization, high-resolution net-pay calculation, well correlation, etc., so can image data from oil-base and synthetics-base mud systems. However, there is a limitation in the circumferential coverage of the borehole using these specialized tools. That is, with respect to the borehole circumferential coverage limitation, due to physical problems in the well during image acquisition, there are intervals in the image where the image is highly distorted due to the tool-string getting stuck in the well and subsequently pulling free, or due to poor hole conditions, or drilling mud anisotropy, or even merely electrical noise. The aforementioned circumferential coverage of the borehole can be greatly increased and the above referenced problems can be corrected by connecting one or more additional imaging tools to a first imaging tool in the tool string, the additional imaging tools having a fixed preset rotational offset and a significant vertical offset with respect to the first imaging tool in the tool string.

### SUMMARY OF INVENTION

Accordingly, an imaging sonde includes a first imaging tool and at least one additional imaging tool connected to the first imaging tool, the additional imaging tool having a fixed preset rotational offset and a significant vertical or longitudinal offset with respect to the first imaging tool in the tool string.

An Oil Based Mud Imaging (OBMI) sonde adapted to be disposed in a wellbore includes four pads which are adapted to extend radially when the sonde is in the wellbore, each of the four pads touching a wall of the wellbore with the pads extended radially in the wellbore. The OBMI sonde is then pulled upwardly to the ground surface at the wellbore, and each of the pads generate a “track” that is adapted to be displayed and/or recorded on an output record medium. A “track” is comprised of a plurality of resistivity curves as a function of depth in the wellbore (five resistivity curves for the OBMI). Since there are four pads on the OBMI sonde, four “tracks” will be recorded and/or displayed on the output record medium. However, since there are four pads on the OBMI sonde, there are four “regions” disposed in between each of the four adjacent pads. As noted earlier, the four pads will survey four portions of the wellbore. However, there are no pads on the OBMI sonde in each of the four “regions”. As a result, since there are no pads on the OBMI sonde in each of the four “regions”, those portions of the wellbore will not be surveyed by the OBMI sonde. As a result, in order to solve this problem, the OBMI sonde includes a first imaging tool and at least one additional imaging tool connected to the first imaging tool via a special adapter, the additional imaging tool having a rotational offset and a significant vertical or longitudinal offset with respect to the first imaging tool in the OBMI tool string. That is, the first imaging tool will, for example, have four pads. The four pads on the first imaging tool will, for example, have a first pad at approximately zero (0) degrees azimuthally, a second pad at approximately ninety (90) degrees azimuthally with respect to the first pad, a third pad at approximately one-hundred eighty (180) degrees azimuthally with respect to the first pad, and a fourth pad at approximately two-hundred seventy (270) degrees azimuthally with respect to the first pad. The additional imaging tool is connected to the first imaging tool via the special adapter. The additional imaging tool will be offset vertically or longitudinally in the wellbore with respect to the first imaging tool by a distance “d” (i.e., the vertical offset). In addition to the vertical or longitudinal offset, the additional imaging tool will also have a rotational offset with respect to the first imaging tool. That is, the additional imaging tool will also have, for example, four pads. However, in addition to the vertical offset, the four pads of the additional imaging tool will, for example, have a first pad at approximately fourty-five (45) degrees azimuthally with respect to the first pad of the first imaging tool, a second pad at approximately one-hundred thirty five (135) degrees azimuthally with respect to the first pad of the first imaging tool, a third pad at approximately two-hundred twenty five (225) degrees azimuthally with respect to the first pad of the first imaging tool, and a fourth pad at approximately three-hundred fifteen (315) degrees azimuthally with respect to the first pad of the first imaging tool. As a result, the four pads of the first imaging tool of the OBMI sonde will survey the four portions of the wellbore that are adjacent the four pads of the first imaging tool. However, in addition, the four pads of the additional imaging tool of the OBMI sonde will also survey the four portions of the wellbore that are adjacent the four “regions” which are located in between the four pads of the first imaging tool. As a result, an output record medium generated by the OBMI sonde of the present invention will include eight tracks instead of the traditional four tracks of a prior art OBMI sonde.

As noted earlier, the first imaging tool is connected to at least one additional imaging tool via the special adapter disposed between the first imaging tool and the additional imaging tool. The first imaging tool plugs into one end of the special adapter, and the additional imaging tool plugs into the other end of the special adapter. The special adapter is made in a special way such that, when the first imaging tool is plugged into the one end of the special adapter and the additional imaging tool is plugged into the other end of the special adapter, the additional imaging tool is “offset rotationally” with respect to the first imaging tool; that is, there is a “rotational offset” or “azimuthal offset” or “angular offset” of the additional imaging tool with respect to the first imaging tool.

As a result of the use of the special adapter disposed between the first imaging tool and the additional imaging tool in the wellbore, the additional imaging tool is “vertically offset” with respect to the first imaging tool. However, in addition, the additional imaging tool is “rotationally offset” with respect to the first imaging tool. When the additional imaging tool is “rotationally offset” with respect to the first imaging tool, the four pads on the first imaging tool will, for example, have a first pad at approximately zero (0) degrees azimuthally, a second pad at approximately ninety (90) degrees azimuthally, a third pad at approximately one-hundred eighty (180) degrees azimuthally, and a fourth pad at approximately two-hundred seventy (270) degrees azimuthally. However, in addition, the four pads on the additional imaging tool will, for example, have a first pad at approximately fourty-five (45) degrees azimuthally, a second pad at approximately one-hundred thirty five (135) degrees azimuthally, a third pad at approximately two-hundred twenty five (225) degrees azimuthally, and a fourth pad at approximately three-hundred fifteen (315) degrees azimuthally.

Further scope of applicability of the present invention will become apparent from the detailed description presented hereinafter. It should be understood, however, that the detailed description and the specific examples, while representing a preferred embodiment of the present invention, are given by way of illustration only, since various changes and modifications within the spirit and scope of the invention will become obvious to one skilled in the art from a reading of the following detailed description.

### BRIEF DESCRIPTION OF DRAWINGS

A full understanding of the present invention will be obtained from the detailed description of the preferred embodiment presented hereinbelow, and the accompanying drawings, which are given by way of illustration only and are not intended to be limitative of the present invention, and wherein:

FIGS. 1 through 4 illustrate a prior art Oil Based Mud Imaging (OBMI) sonde;

FIG. 4A illustrates an output record medium generated by the OBMI sonde of the prior art, the output recording medium having four tracks corresponding, respectively, to the four pads on the OBMI sonde;

FIG. 5 illustrates a dual Oil Based Mud Imaging sonde (hereinafter referred to as a “dual OBMI sonde”) of the present invention including a first imaging tool and a second additional imaging tool connected to the first imaging tool, the second additional imaging tool being rotationally and vertically offset with respect to the first imaging tool;

FIG. 6 illustrates a top view of the first imaging tool of the dual OBMI sonde of FIG. 5 taken along section lines 6-6 of FIG. 5;

FIG. 7 illustrates a top view of the second imaging tool of the dual OBMI sonde of FIG. 5 taken along section lines 7-7 of FIG. 5;

FIG. 8A illustrates another view of the dual OBMI sonde of FIG. 5;

FIG. 8B illustrates a view of the first imaging tool of the dual OBMI sonde of FIG. 8A;

FIG. 8C illustrates a view of the second additional imaging tool of the dual OBMI sonde of FIG. 8A;

FIG. 9 illustrates a top view of the prior art OBMI sonde of FIGS. 1 and 3, this top view showing an OBMI sonde having four pads, each pad adapted to touch a side wall of the wellbore;

FIG. 10 illustrates another top view of the first imaging tool of the dual OBMI sonde of FIG. 5 taken along section lines 6-6 of FIG. 5 (this is similar to the top view shown in FIG. 6);

FIG. 11 illustrates a construction of the “special adapter” which interconnects the second additional imaging tool to the first imaging tool of the dual OBMI sonde of FIG. 5 of the present invention;

FIG. 12 illustrates a comparison of an output record medium generated by the prior art OBMI sonde of FIGS. 1 through 4 showing four tracks against the output record medium generated by the dual OBMI sonde of the present invention showing eight tracks; and

FIGS. 13 and 14 illustrate a more detailed view of the output record medium generated by the dual OBMI sonde of the present invention showing eight tracks including four tracks generated by the four pads on the first imaging tool and four additional tracks generated by the four pads on the second additional imaging tool of the dual OBMI sonde of the present invention.

### DETAILED DESCRIPTION

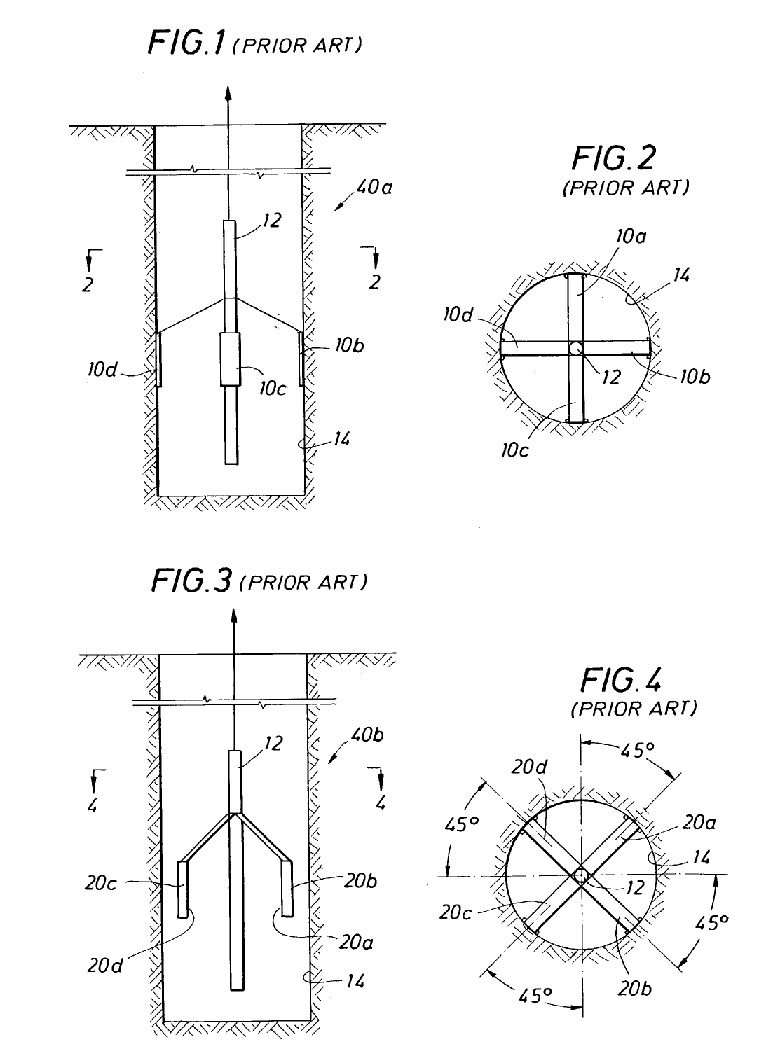

Referring to FIGS. 1 and 2, a first prior art Oil Based Mud Imaging (OBMI) sonde 40a is illustrated.

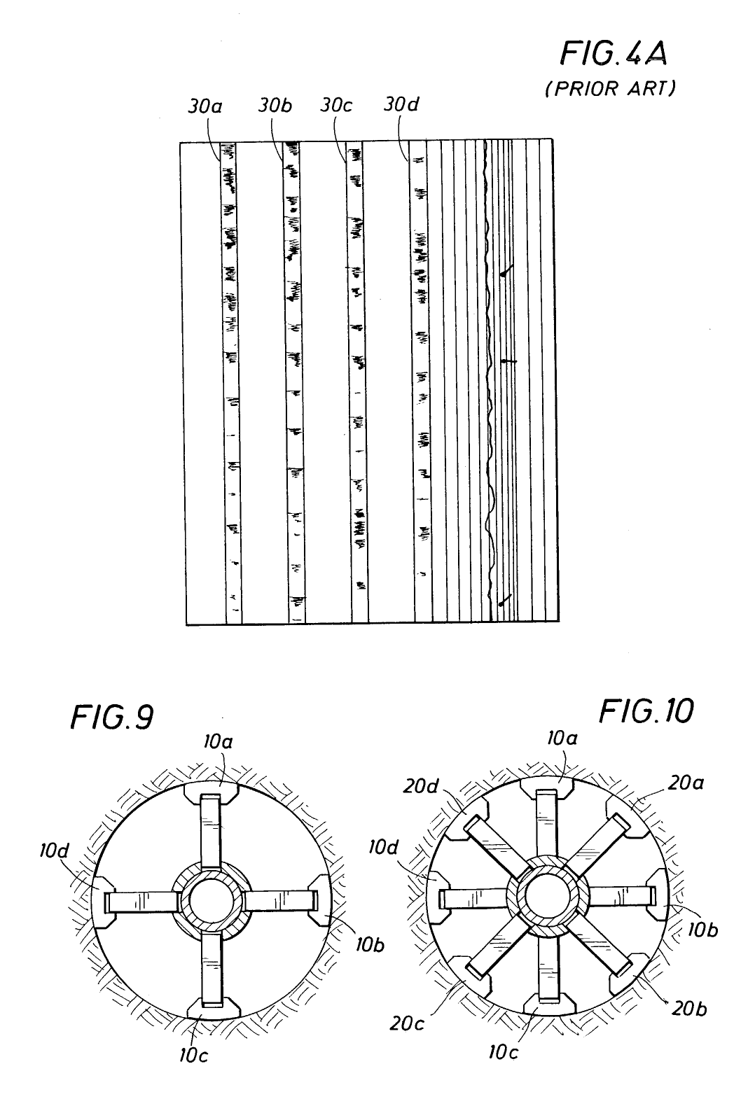

In FIG. 1, the first OBMI sonde 40a includes four pads 10a-10d adapted to touch a wall of the wellbore when the OBMI sonde is pulled upwardly to a surface of the wellbore. The OBMI sonde 40a of FIG. 1 is owned and operated by Schlumberger Technology Corporation of Houston, Tex. The four pads include a first pad 10a (not shown in FIG. 1) mounted on a central shaft 12, a second pad 10b mounted to the central shaft 12, a third pad 10c and a fourth pad 10d both mounted to the central shaft 12. In FIG. 1, the four pads 10a-10d are shown in their extended position, the pads extending radially outward until the pads touch a wall 14 of the wellbore. When the pads touch the wall 14 of the wellbore, the OBMI sonde 40a of FIG. 1 is pulled upwardly to a surface of the wellbore and, responsive thereto, an output record medium (see FIG. 4A) is generated having four tracks corresponding, respectively, to the four pads 10a-10d on the OBMI sonde. The four tracks each represent resistivity curves as a function of depth in the wellbore. The four tracks will be discussed later in this specification.

In FIG. 2, a top view of the first OBMI sonde 40a of FIG. 1, taken along section lines 2-2 of FIG. 1, is illustrated. In FIG. 2, the first OBMI sonde 40a includes the four pads including pad 10a and pad 10b and pad 10c and pad 10d. The four pads 10a-10d are each connected to the central shaft 12, the pads 10a-10d being shown in their extended position. That is, the pads 10a-10d have been extended radially outward until the pads 10a-10d each touch a wall 14 of the wellbore. In this position, the first OBMI sonde 40a of FIG. 2 is ready to be pulled upwardly to a surface of the wellbore and, responsive thereto, the output record medium including the four tracks of FIG. 4A will be generated (one track for each pad 10a-10d).

Referring to FIGS. 3 and 4, a second prior art Oil Based Mud Imaging (OBMI) sonde 40b of FIGS. 1 and 2 is illustrated. However, in FIGS. 3 and 4, the pads are rotationally offset.

In FIG. 3, the second OBMI sonde 40b includes four pads 20a-20d adapted to touch a wall 14 of the wellbore when the OBMI sonde is pulled upwardly to a surface of the wellbore. The OBMI sonde 40b of FIG. 3 is owned and operated by Schlumberger Technology Corporation of Houston, Tex. The four pads include a first pad 20a mounted on a central shaft 12, a second pad 20b mounted to the central shaft 12, a third pad 20c and a fourth pad 20d both mounted to the central shaft 12. In FIG. 3, the four pads 20a-20d are shown in their extended position, the pads extending radially outward until the pads touch a wall 14 of the wellbore. When the pads touch the wall 14 of the wellbore, the second OBMI sonde 40b of FIG. 3 is pulled upwardly to a surface of the wellbore and, responsive thereto, an output record medium (see FIG. 4A) is generated having four tracks corresponding, respectively, to the four pads 20a-20d on the OBMI sonde. The four tracks each represent resistivity curves as a function of depth in the wellbore. The four tracks will be discussed later in this specification. In FIG. 3, however, the pads 20a-20d have been “rotationally offset”; that is, the pads 20a-20d have been rotated azimuthally until the pads 20a-20d are offset azimuthally by an angle of approximately 45 degrees relative to the position of the pads 10a-10d in FIGS. 1 and 2. This “rotationally offset” feature is best illustrated in FIG. 4.

In FIG. 4, a top view of the second OBMI sonde 40b of FIG. 3, taken along section lines 4-4 of FIG. 3, is illustrated. In FIG. 4, the second OBMI sonde 40b includes the four pads including pad 20a and pad 20b and pad 20c and pad 20d. The four pads 20a-20d are each connected to the central shaft 12, the pads 20a-20d being shown in their extended position. That is, the pads 20a-20d have been extended radially outward until the pads 20a-20d each touch a wall 14 of the wellbore. In this position, the OBMI sonde 40b of FIG. 3 is ready to be pulled upwardly to a surface of the wellbore and, responsive thereto, the output record medium including the four tracks of FIG. 4A will be generated (one track for each pad 20a-20d). In FIG. 4, the first pad 20a has been “offset rotationally” or “offset azimuthally” by an angle of approximately 45 degrees with respect to the position of pad 10a of FIG. 2. Similarly, the second pad 20b has been “offset rotationally” by an angle of approximately 45 degrees with respect to the position of pad 10b of FIG. 2. The third pad 20c has been “offset rotationally” by an angle of approximately 45 degrees with respect to the position of pad 10c of FIG. 2. The fourth pad 20d has been “offset rotationally” by an angle of approximately 45 degrees with respect to the position of pad 10d of FIG. 2. However, the second OBMI sonde 40b of FIGS. 3 and 4 is identical to the first OBMI sonde 40a of FIGS. 1 and 2, even though the pads 20a-20d in FIG. 4 have been “rotationally offset” or “azimuthally offset” or “angularly offset” relative to the position of pads 10a-10d in FIG. 2.

Referring to FIG. 4A, the output record medium produced by the OBMI sonde 40a and 40b of FIGS. 1-4 is illustrated. In FIG. 4A, the output record medium includes four tracks, a first track 30a corresponding to pad 10a or 20a, a second track 30b corresponding to pad 10b or 20b, a third track 30c corresponding to pad 10c or 20c, and a fourth track 30d corresponding to pad 10d or 20d. When the OBMI sonde 40a or 40b of FIGS. 1-4 is pulled upwardly to a surface of the wellbore, an output record medium is generated which includes the four tracks 30a-30d. Each track 30a-30d includes a plurality of resistivity curves as a function of depth. That is, each pad 10a-10d and 20a-20d includes a plurality of button pairs (typically five button pairs in OBMI). When the OBMI sonde 40a or 40b is pulled upwardly to the surface of at the wellbore, the plurality of button pairs generate a corresponding plurality of resistivity curves as a function of depth in the wellbore. Since there are typically five button pairs on each pad 10a-10d/20a-20d, five resistivity curves will be generated for each pad, one resistivity curve as a function of depth in the wellbore for each button pair on each pad. The five button pairs on each pad comprise a “track”. Therefore, for each pad, the five resistivity curves generated by each pad will comprise a “track”. In FIG. 4A, four “tracks” are illustrated, tracks 30a-30d. Each “track” 30a-30d will provide an indication of resistivity as a function of depth in the wellbore for each corresponding pad 10a-10d/20a-20d on the OBMI sonde 40a or 40b.

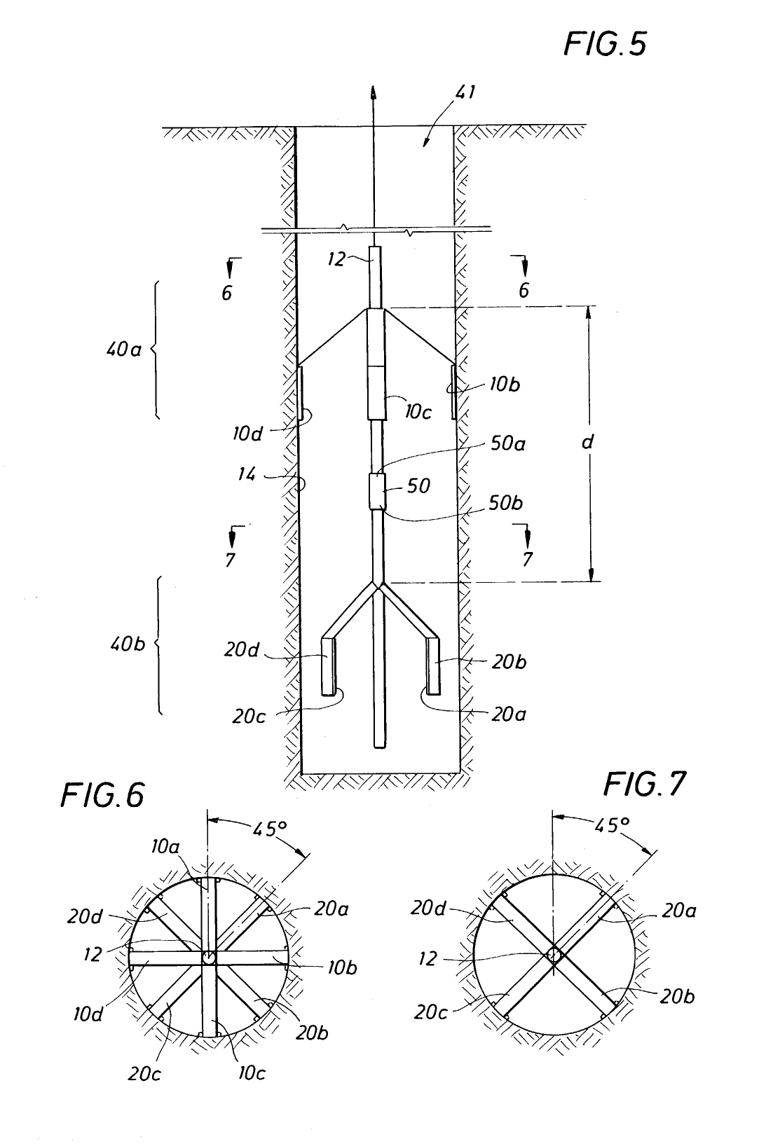

Referring to FIGS. 5, 6, and 7, the dual Oil Based Mud Imaging Sonde (dual OBMI sonde) 41, in accordance with the present invention, is illustrated.

In FIG. 5, the dual OBMI sonde 41 includes the first OBMI sonde 40a connected to the second OBMI sonde 40b via a special adapter 50. The first OBMI sonde 40a of FIGS. 1 and 2 including pads 10a-10d is connected to the second OBMI sonde 40b of FIGS. 3 and 4 including pads 20a-20d via a special adapter 50. That is, the first OBMI sonde 40a of FIGS. 1 and 2 is connected to an upper end 50a of the special adapter 50, and the second OBMI sonde 40b of FIGS. 3 and 4 is connected to a lower end 50b of the special adapter 50. When the special adapter 50 interconnects the first OBMI sonde 40a of FIGS. 1 and 2 at its upper end 50a to the second OBMI sonde 40b of FIGS. 3 and 4 at its lower end 50b, the second OBMI sonde 40b including pads 20a-20d is “rotationally offset” by a predetermined angle (in this embodiment, approximately 45 degrees) relative to the first OBMI sonde 40a including pads 10a-10d. In addition, when the special adapter 50 interconnects the first OBMI sonde 40a of FIGS. 1 and 2 at its upper end 50a to the second OBMI sonde 40b of FIGS. 3 and 4 at its lower end 50b, the second OBMI sonde 40b including pads 20a-20d is “vertically offset” or “longitudinally offset” by a distance “d” from the first OBMI sonde 40a including pads 10a-10d. For example, in FIG. 5, note that the second OBMI sonde 40b is spaced by a vertical or longitudinal distance “d” from the first OBMI sonde 40a. The term “vertically offset” refers to the distance “d” in FIG. 5 when the first and second OBMI tools 40a and 40b are disposed in the wellbore. However, in any event, the second OBMI tool 40b is “longitudinally offset” from the first OBMI tool 40a along the longitudinal axial length of the dual OBMI sonde 40 of FIG. 5 because the second OBMI tool 40b is spaced by a distance “d” from the first OBMI tool 40a along the longitudinal axial length of the dual OBMI sonde 41. The “rotationally offset” feature can best be seen in FIGS. 6 and 7 of the drawings.

In FIG. 6, a top view of the dual OBMI sonde 41 of FIG. 5, taken along section lines 6-6 of FIG. 5, is illustrated. In FIG. 6, recall that the first OBMI sonde 40a included pads 10a, 10b, 10c, and 10d (see FIG. 2). In FIG. 6, the first pad 10a of the first OBMI sonde 40a is azimuthally located at approximately zero (0) degrees, the second pad 10b is azimuthally located at approximately ninety (90) degrees relative to pad 10a, the third pad 10c is azimuthally located at approximately one-hundred eighty (180) degrees relative to pad 10a, and the fourth pad 10d is azimuthally located at approximately two-hundred seventy (270) degrees relative to pad 10a. However, in FIG. 6, recall that the second OBMI sonde 40b included pads 20a, 20b, 20c, and 20d (see FIG. 4). In FIG. 6, the second OBMI sonde 40b is “rotationally offset” relative to the first OBMI sonde 40a because the pads 20a-20d of the second OBMI sonde 40b are rotated clockwise by an angle of approximately 45 degrees with respect to the pads 10a-10d of the first OBMI sonde 40a. That is, in order to fully understand the “rotationally offset” feature, note the following angular dimensions: in FIG. 6, the first pad 20a of the second OBMI sonde 40b is azimuthally located at approximately fourty five (45) degrees relative to pad 10a of the first OBMI sonde 40a, the second pad 20b is azimuthally located at approximately 45 degrees relative to pad 10b, the third pad 20c is azimuthally located at approximately 45 degrees relative to pad 10c, and the fourth pad 20d is azimuthally located at approximately 45 degrees relative to pad 10d.

In FIG. 7, a top view of the second OBMI sonde 40b of FIG. 5 taken along section lines 7-7 of FIG. 5 is illustrated. In FIG. 7, the second OBMI sonde 40b, including pads 20a-20b (of FIG. 4), is shown as having pads 20a-20d that are “rotationally offset” by an angle of approximately 45 degrees with respect to the pads 10a-10d of the first OBMI sonde 40a. In particular, in FIG. 7, pad 20a is rotated clockwise by an angle of approximately 45 degrees with respect to pad 10a of the first OBMI sonde 40a. Similarly, pad 20b is rotated clockwise by an angle of approximately 45 degrees with respect to pad 10b of the first OBMI sonde 40a. Pad 20c is rotated clockwise by an angle of approximately 45 degrees with respect to pad 10c of the first OBMI sonde 40a. Pad 20d is rotated clockwise by an angle of approximately 45 degrees with respect to pad 10d of the first OBMI sonde 40a.

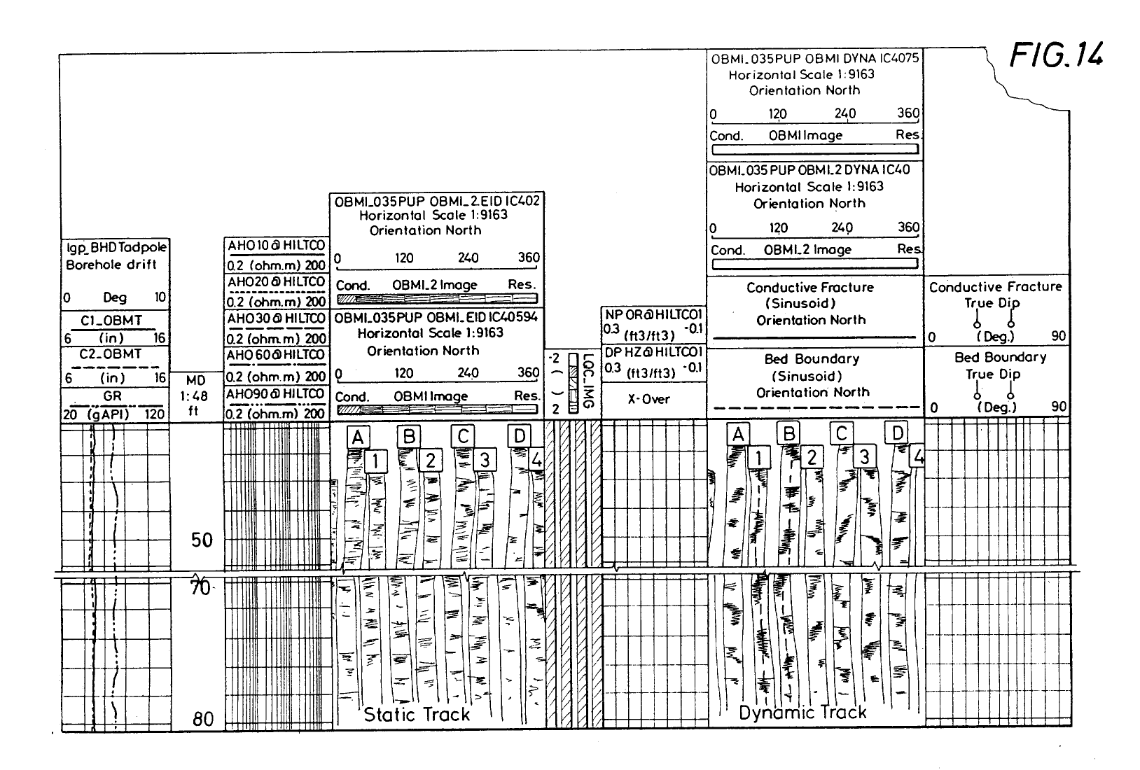

In FIGS. 5 and 6, when the dual OBMI sonde 41 of FIG. 5 is pulled upwardly to a surface of the wellbore, the pads 10a, 10b, 10c, and 10d of the first OBMI sonde 40a will survey the wall 14 of the wellbore at the following azimuthal or angular locations relative to the location of pad 10a: zero (0) degrees using pad 10a, ninety (90) degrees using pad 10b, one-hundred eighty (180) degrees using pad 10c, and two-hundred seventy (270) degrees using pad 10d. However, the pads 20a, 20b, 20c, and 20d of the second OBMI sonde 40b will survey the wall 14 of the wellbore at the following azimuthal or angular locations relative to the location of pad 10a: fourty five (45) degrees using pad 20a, one-hundred thirty five (135) degrees using pad 20b, two-hundred twenty five (225) degrees using pad 20c, and three-hundred fifteen (315) degrees using pad 20d. The term “survey the wall 14 of the wellbore” means that the pads 10a-20d will touch and rub-against the wall 14 of the wellbore when the dual OBMI sonde 40 is being pulled upwardly to a surface of the wellbore; and, responsive thereto, an output record medium will be generated (such as a well log or other graphical chart) where the output record medium will display a plurality of “tracks” (such as the eight tracks seen in FIG. 13) which correspond, respectively, to the plurality of pads 10a-10d/20a-20d used by the dual OBMI tool 41 of FIG. 5.

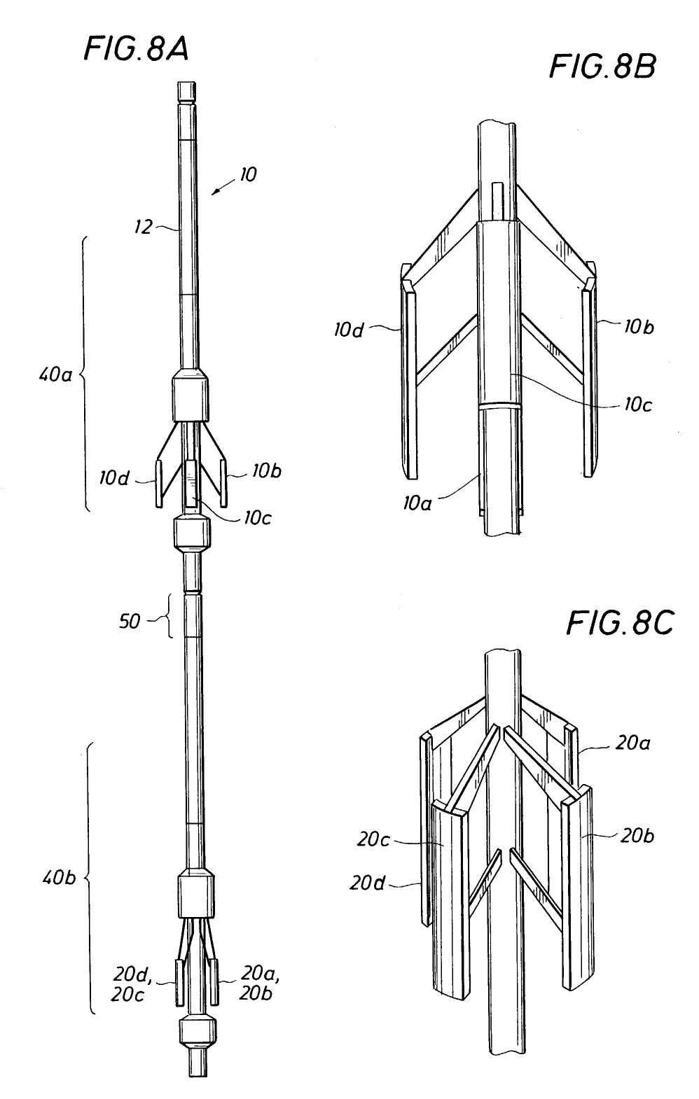

Referring to FIGS. 8A, 8B, and 8C, another more realistic view of the dual OBMI sonde 41 in accordance with the present invention is illustrated. In FIG. 8A, the dual OBMI sonde 41 includes the first OBMI tool 40a connected to the second OBMI tool 40b via a special adapter 50. The first OBMI tool 40a includes pads 10a, 10b, 10c, and 10d. The second OBMI tool 40b includes pads 20a, 20b, 20c, and 20d. The pads 10a, 10b, 10c, and 10d of the first OBMI tool 40a are shown in their extended position (extended radially outward) for touching the wall 14 of the wellbore. The angular or azimuthal position of the pads 10a, 10b, 10c, and 10d on the first OBMI tool 40a relative to pad 10a of the first OBMI tool 40a are: 0 degrees for pad 10a, 90 degrees for pad 10b, 180 degrees for pad 10c, and 270 degrees for pad 10d. The pads 20a, 20b, 20c, and 20d of the second OBMI tool 40b are shown in their extended position (extended radially outward) for touching the wall 14 of the wellbore. The angular or azimuthal position of the pads 20a, 20b, 20c, and 20d on the second OBMI tool 40b relative to pad 10a of the first OBMI tool 40a are: 45 degrees for pad 20a, 135 degrees for pad 20b, 225 degrees for pad 20c, and 315 degrees for pad 20d. As a result, the pads 20a-20d of the second OBMI tool 40b will survey (i.e., develop tracks like those shown in FIG. 13) the azimuthally oriented regions of the wellbore which are disposed in-between adjacent pads (i.e., in-between adjacent pads 10a-10b, 10b-10c, 10c-10d, and 10d-10a) of the first OBMI tool 40a. Therefore, instead of generating four tracks similar to the four tracks shown in FIG. 4A generated by the prior art OBMI tool of FIGS. 1-4, the dual OBMI sonde 41 of the present invention will generate eight tracks similar to the eight tracks shown in FIG. 13. In FIG. 8B, the four pads 10a, 10b, 10c, and 10d of the first OBMI tool 40a are shown in their extended position, pad 10a being at 0 degrees, pad 10b being at 90 degrees relative to pad 10a, pad 10c being at 180 degrees relative to pad 10a, and pad 10d being at 270 degrees relative to pad 10a. In FIG. 8C, the four pads 20a, 20b, 20c, and 20d of the second OBMI tool 40b are shown in their extended position, pad 20a being at 45 degrees relative to pad 10a, pad 20b being at 135 degrees relative to pad 10a, pad 20c being at 225 degrees relative to pad 10a, and pad 20d being at 315 degrees relative to pad 10a.

Referring to FIG. 9, a more realistic top view of the prior art OBMI sonde 40a of FIG. 1, taken along section lines 2-2 of FIG. 1, is illustrated. Note that the pads 10a-10d are in their extended position adapted to touch an internal wall 14 of the wellbore. Pad 10a is located at an azimuthal angle of 0 degrees relative to pad 10a, pad 10b is located at 90 degrees relative to pad 10a, pad 10c is located at 180 degrees relative to pad 10a, and pad 10d is located at 270 degrees relative to pad 10a.

Referring to FIG. 10, a more realistic top view of the dual OBMI sonde 41 of the present invention of FIG. 5 taken along section lines 6-6 of FIG. 5 is illustrated. Compare FIG. 6 with FIG. 10 and note that the pads 10a-10d, 20a-20d are in their extended position adapted to touch an internal wall 14 of the wellbore. Pads 10a-10d belong to the first OBMI tool 40a, and pads 20a-20d belong to the second OBMI tool 40b. Pad 10a is located at an azimuthal angle of 0 degrees relative to pad 10a, pad 20a is located at 45 degrees relative to pad 10a, pad 10b is located at 90 degrees relative to pad 10a, pad 20b is located at 135 degrees relative to pad 10a, pad 10c is located at 180 degrees relative to pad 10a, pad 20c is located at 225 degrees relative to pad 10a, pad 10d is located at 270 degrees relative to pad 10a, and pad 20d is located at 315 degrees relative to pad 10a. Yet, pads 20a-20d of the second OBMI tool 40b are “vertically offset” or “longitudinally offset” from pads 10a-10d of the first OBMI tool 40a when the dual OBMI sonde 41 is disposed in a wellbore. As a result, the four pads 10a-10d of the first imaging tool 40a of the dual OBMI sonde 41 will survey the four portions of the wellbore that are adjacent to the four pads 10a-10d. However, in addition, the four pads 20a-20d of the additional imaging tool 40b of the dual OBMI sonde 41 will also survey the four portions of the wellbore that are adjacent to the four “regions” which are located in between the four pads 10a-10d of the first imaging tool 40a.

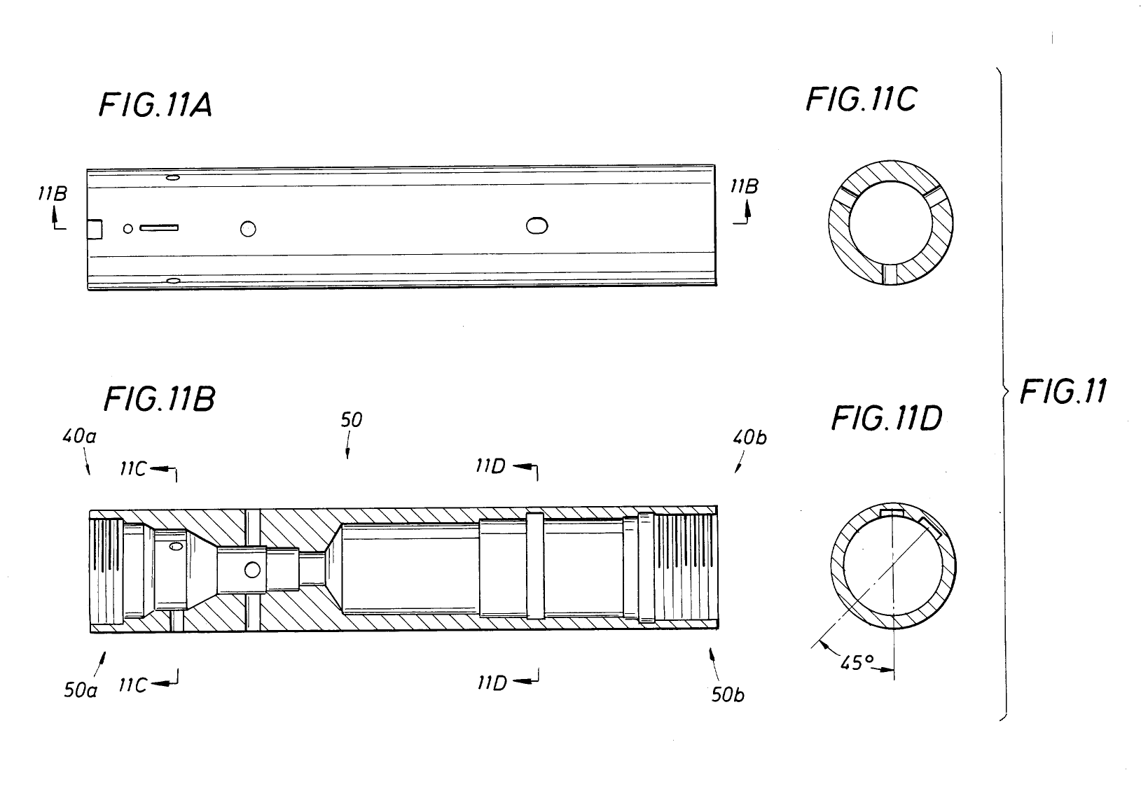

Referring to FIG. 11, a construction of the special adapter 50 of FIGS. 5 and 8A is illustrated. In FIG. 11, the special adapter 50 includes a first end 50a adapted to receive a end of the first OBMI tool 40a and a second end 50b adapted to receive an end of the second OBMI tool 40b. When the end of the first OBMI tool 40a is plugged into the first end 50a of the special adapter 50, and when the end of the second OBMI tool 40b is plugged into the second end 50b of the special adapter 50, the pads 20a-20d of the second OBMI tool 40b will automatically be “rotationally offset” or “azimuthally offset” or “angularly offset” relative to the pads 10a-10d of the first OBMI tool 40a. This is because the special adapter 50 is specially manufactured in order to “rotationally offset” the pads 20a-20d of the second OBMI tool 40b relative to the pads 10a-10d of the first OBMI tool 40a (where the term “rotationally offset” is meant to indicate that pad 20a is rotated clockwise an azimuthal angle of 45 degrees with respect to pad 10a, pad 20b is rotated clockwise an azimuthal angle of 45 degrees with respect to pad 10b, pad 20c is rotated clockwise an azimuthal angle of 45 degrees with respect to pad 10c, and pad 20d is rotated clockwise an azimuthal angle of 45 degrees with respect to pad 10d).

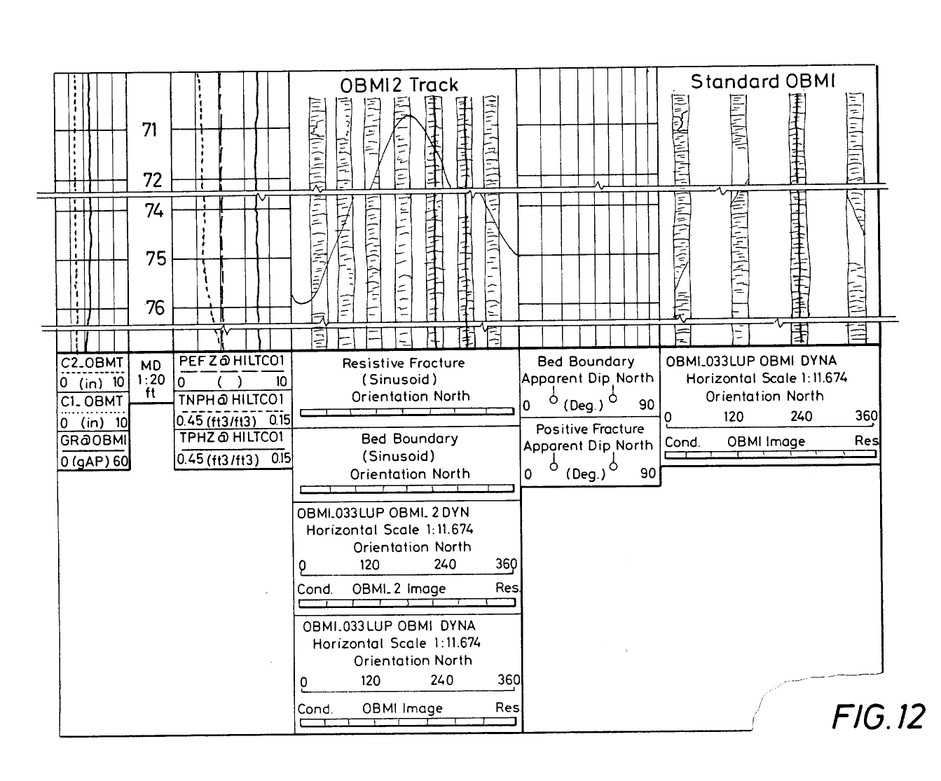

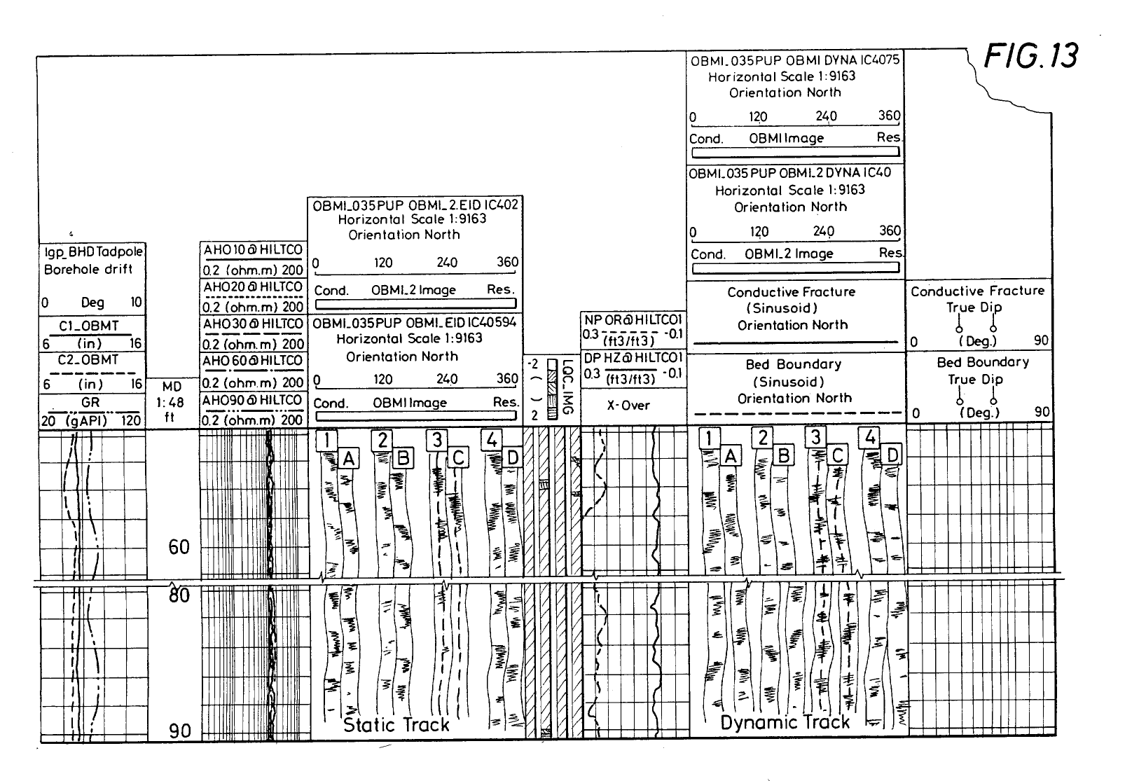

Referring to FIG. 12, a comparison of output records is illustrated whereby an output record medium generated by the prior art OBMI sonde of FIGS. 1 through 4 showing four (4) tracks is being compared against the output record medium generated by the dual OBMI sonde 41 of the present invention showing eight (8) tracks. In FIG. 12, the presentation shows an image acquired by the dual OBMI sonde 41 of the present invention having eight (8) tracks (labeled “OBMI2 track”) and a standard prior art OBMI tool having four (4) tracks (labeled “Standard OBMI”). Notice the much more distinctly visible high apparent angle fractures (see the sinusoid in FIG. 12) in the “OBMI2 track” image.

Referring to FIGS. 13 and 14, a more detailed view of the output record medium generated by the dual OBMI sonde 41 of the present invention is illustrated, FIGS. 13 and 14 showing eight tracks including four tracks generated by the four pads 10a-10d on the first imaging tool 40a and four additional tracks generated by the four pads 20a-20d on the second additional imaging tool 40b of the dual OBMI sonde 41 of the present invention.

In FIG. 13, this presentation shows images acquired by dual OBMI sonde 41 (i.e., the “OBMI2”) of the present invention. The static and dynamic tracks are labeled accordingly. The image segment acquired by each pad has been labeled as 1, 2, 3, 4 (acquired by the first tool 40a) and labeled as A, B, C, D (acquired by the second tool 40b). Looking at image segments from Pads 1, 2, 3 and 4 in the Static Track, it is observed that, at depth xx,x58 71 ft, the image segments are almost uniform in color. This corresponds to a time frame during data acquisition when the tool was stuck in the borehole, but continued to record data, and then pulled free. Once processed, this data appears as a “smear” on the image, as seen at depth xx,x58 71 ft in the image segments from Pads 1, 2, 3 and 4. When the first tool was stuck at the depth xx,x71 ft, the second tool (with fixed vertical offset from the first tool) was stuck at depth xx,x88 ft and caused a “smear” at depth xx,x75 88 ft (image segments from Pads A, B, C and D). However, when the first tool had passed this interval earlier, neither tool was stuck and the first tool had recorded a true data image (see image segments from Pads 1, 2, 3 and 4 at depth xx,x75 88 ft). Further, once the tools had broken free, the second tool passed through the zone that the first tool had “smeared” (depth xx,x58 71 ft) and the second tool recorded a true data image (image segments from Pads A, B, C and D). In this way, the second tool compensated for the loss of data by the first tool, and vice versa, and thus provided complete vertical coverage.

In FIG. 14, this presentation also shows images acquired by the dual OBMI sonde 41 (i.e., the OBMI2) of the present invention. The static and dynamic tracks are labeled accordingly. The image segment acquired by each pad has been labeled as 1, 2, 3, 4 (acquired by the first tool) and labeled as A, B, C, D (acquired by the second tool). Looking at image segments from Pads 1, 2, 3 and 4 in the Static Track, it is observed that at depth xx,x45.5 61.5 ft the image segments have only slight variation in color. This corresponds to a time frame during data acquisition when the tool was stuck in the borehole, but continued to record data, and then pulled free. Once processed, this data appears as a “smear” on the image, as seen at depth xx,x45.5 61.5 ft in the image segments from Pads 1, 2, 3 and 4. When the first tool was stuck at the depth xx,x61.5 ft, the second tool (with fixed vertical offset from the first tool) was stuck at depth xx,x78.5 ft and caused a “smear” at depth xx,x62.5 78.5 ft (image segments from Pads A, B, C and D). However, when the first tool had passed this interval earlier, neither tool was stuck and the first tool had recorded a true data image (see image segments from Pads 1, 2, 3 and 4 at depth xx,x62.5 78.5 ft). Further, once the tools had broken free, the second tool passed through the zone that the first tool had “smeared” (depth xx,x45.5 61.5 ft) and the second tool recorded a true data image (image segments from Pads A, B, C and D). In this way, the second tool compensated for the loss of data by the first tool, and vice versa, and thus provided complete vertical coverage.

A functional description of the operation of the dual OBMI sonde 41 of FIG. 5 of the present invention will be set forth in the following paragraph with reference to FIGS. 1 through 13 of the drawings.

The dual OBMI sonde 41 of FIG. 5 is positioned in a wellbore as shown. The pads 10a-10d of the first OBMI tool 40a are located at the following angular positions relative to pad 10a: 0 degrees, 90 degrees, 180 degrees, and 270 degrees; however, the pads 20a-20d of the second OBMI tool 40b are located at the following angular positions relative to pad 10a: 45 degrees, 135 degrees, 225 degrees, and 315 degrees. An operator at the surface of the wellbore will now pull the dual OBMI sonde 41 of FIG. 5 upwardly to the surface. The pads 10a-10d and 20a-20d are actually touching the side walls of the wellbore 14 when the dual OBMI sonde 41 is pulled upwardly to the surface of the wellbore. Recalling that pads 10a-10d of the first OBMI sonde 40a of FIG. 5 will touch the side walls of the wellbore at the following angular degrees: 0, 90, 180, and 270; and recalling that the pads 20a-20d of the second OBMI sonde 40b of FIG. 5 will touch the side walls of the wellbore at the following angular degrees: 45, 135, 225, 315, when the dual OBMI sonde 41 of FIG. 5 is pulled upwardly to the surface of the wellbore, a new and novel output record medium will be generated and that new and novel output record medium will have the eight (8) tracks shown in FIG. 13 instead of the four tracks in FIG. 4A generated by the prior art OBMI tool of FIGS. 1-4. As a result, more wellbore features can be seen on the eight-track output record medium of FIG. 13. That is, since there are eight tracks in FIG. 13 instead of the four tracks in FIG. 4A, more Earth formation features disposed on the side wall 14 of the wellbore of FIG. 5 will be visible on the eight tracks of the output record medium shown in FIG. 13.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A logging tool adapted to be disposed in a wellbore, comprising:
a first tool including a first plurality of pads adapted to touch a wall of the wellbore when said logging tool is disposed in said wellbore;
a second tool including a second plurality of pads adapted to touch a wall of the wellbore when said logging tool is disposed in said wellbore,
the second tool being longitudinally offset from the first tool with said logging tool is disposed in said wellbore,
the second plurality of pads of said second tool being rotationally offset relative to the first plurality of pads of said first tool.

2. The logging tool of claim 1, wherein said first plurality of pads of said first tool include a first pad, a second pad spaced angularly from said first pad, a third pad spaced angularly from said second pad, and a fourth pad spaced angularly from said third pad.

3. The logging tool of claim 2, wherein said second plurality of pads of said second tool include a first pad, a second pad spaced angularly from said first pad, a third pad spaced angularly from said second pad, and a fourth pad spaced angularly from said third pad.

4. The logging tool of claim 3, wherein said first pad of said second tool is rotationally offset from said first pad of said first tool by a predetermined angle, said first pad of said second tool being longitudinally offset from said first pad of said first tool by an approximate distance “d”.

5. The logging tool of claim 4, wherein said second pad of said second tool is rotationally offset from said second pad of said first tool by said predetermined angle, said second pad of said second tool being longitudinally offset from said second pad of said first tool by an approximate distance “d”.

6. The logging tool of claim 5, wherein said third pad of said second tool is rotationally offset from said third pad of said first tool by said predetermined angle, said third pad of said second tool being longitudinally offset from said third pad of said first tool by an approximate distance “d”.

7. The logging tool of claim 6, wherein said fourth pad of said second tool is rotationally offset from said fourth pad of said first tool by said predetermined angle, said fourth pad of said second tool being longitudinally offset from said fourth pad of said first tool by an approximate distance “d”.

8. A method of logging a well, comprising the steps of:
pulling a dual sonde upwardly to the surface at the wellbore, the dual sonde including,
a first sonde including a first plurality of pads adapted to touch an interior wall of the wellbore, the first plurality of pads having a number of pads, and
a second sonde connected to the first sonde and longitudinally spaced from the first sonde and including a second plurality of pads adapted to touch said interior wall of the wellbore, said second plurality of pads having a number of pads, the second plurality of pads of said second sonde being rotationally offset relative to said first plurality of pads of said first sonde, the pulling step including the steps of,
pulling said first sonde and said second sonde upwardly to the surface at the wellbore when the first and second sonde are disposed in the wellbore and when said first plurality of pads and said second plurality of pads are touching said interior wall of said wellbore, and
generating an output record medium in response to the step of pulling said first sonde and said second sonde upwardly to said surface of the wellbore, the output record medium including a plurality of tracks, said plurality of tracks of said output record medium being equal in number to the number of pads of said first plurality of pads plus the number of pads of said second plurality of pads.

9. The method of claim 8, wherein said first plurality of pads of said first sonde include a first pad, a second pad spaced angularly from said first pad, a third pad spaced angularly from said second pad, and a fourth pad spaced angularly from said third pad.

10. The method of claim 9, wherein said second plurality of pads of said second sonde include a first pad, a second pad spaced angularly from said first pad, a third pad spaced angularly from said second pad, and a fourth pad spaced angularly from said third pad.

11. The method of claim 10, wherein said first pad of said second sonde is rotationally offset from said first pad of said first sonde by a predetermined angle, said first pad of said second sonde being longitudinally offset from said first pad of said first sonde by an approximate distance “d”.

12. The method of claim 11, wherein said second pad of said second sonde is rotationally offset from said second pad of said first sonde by said predetermined angle, said second pad of said second sonde being longitudinally offset from said second pad of said first sonde by an approximate distance “d”.

13. The method of claim 12, wherein said third pad of said second sonde is rotationally offset from said third pad of said first sonde by said predetermined angle, said third pad of said second sonde being longitudinally offset from said third pad of said first sonde by an approximate distance “d”.

14. The method of claim 13, wherein said fourth pad of said second sonde is rotationally offset from said fourth pad of said first sonde by said predetermined angle, said fourth pad of said second sonde being longitudinally offset from said fourth pad of said first sonde by an approximate distance “d”.

15. An imaging tool adapted to be disposed in a wellbore, comprising:
a first imaging tool including a first plurality of pads;
a second imaging tool including a second plurality of pads, said second plurality of pads being longitudinally offset with respect to said first plurality of pads, said second plurality of pads being rotationally offset with respect to said first plurality of pads; and
an adapter interconnected between said first imaging tool and said second imaging tool, an end of said first imaging tool being connected to one end of said adapter, an end of said second imaging tool being connected to the other end of said adapter,
said second plurality of pads being rotationally offset with respect to said first plurality of pads when the end of said first imaging tool is connected to said one end of said adapter and the end of said second imaging tool is connected to said other end of said adapter.

16. The imaging tool of claim 15, wherein said first plurality of pads includes a first pad, a second pad angularly spaced from said first pad, a third pad angularly spaced from said second pad, and a fourth pad angularly spaced from said third pad, said second plurality of pads including a fifth pad longitudinally spaced from said first pad, a sixth pad longitudinally spaced from said second pad and angularly spaced from said fifth pad, a seventh pad longitudinally spaced from said third pad and angularly spaced from said sixth pad, and an eighth pad longitudinally spaced from said fourth pad and angularly spaced from said seventh pad.

17. The imaging tool of claim 16, wherein said fifth pad of said second plurality of pads of said second imaging tool is rotationally offset by a predetermined angle with respect to said first pad of said first plurality of pads of said first imaging tool.

18. The imaging tool of claim 17, wherein said sixth pad of said second plurality of pads of said second imaging tool is rotationally offset by a predetermined angle with respect to said second pad of said first plurality of pads of said first imaging tool.

19. The imaging tool of claim 18, wherein said seventh pad of said second plurality of pads of said second imaging tool is rotationally offset by a predetermined angle with respect to said third pad of said first plurality of pads of said first imaging tool.

20. The imaging tool of claim 19, wherein said eighth pad of said second plurality of pads of said second imaging tool is rotationally offset by a predetermined angle with respect to said fourth pad of said first plurality of pads of said first imaging tool.
